(19) United States
(12) Patent Application Publication
(10) Pub. No.: US 2022/0051823 A1
(43) Pub. Date: Feb. 17, 2022

(54) APPARATUS AND METHOD FOR GROUT WASTE DISPOSAL

(71) Applicant: Avantech, LLC, Columbia, SC (US)

(72) Inventors: Tracy A. Barker, Columbia, SC (US); Michael F. Reed, Columbia, SC (US); Zachary T. Wallick, Columbia, SC (US); Connor D. Shull, Columbia, SC (US)

(21) Appl. No.: 17/404,564

(22) Filed: Aug. 17, 2021

Related U.S. Application Data
(60) Provisional application No. 63/066,618, filed on Aug. 17, 2020.

(51) Int. Cl. G21C 19/32; B65G 65/40

(52) U.S. Cl. CPC G21C 19/32; B65G 65/40

(57) ABSTRACT

A disposal system is provided for transferring material to a container. The disposal system includes a discharge chute having a mating surface. The mating surface is configured to engage with a container, and the discharge chute is configured to extend and retract so that the mating surface moves along a path between an extended position and a retracted position. The disposal system also includes at least one controller that is configured to cause the discharge chute to extend and retract.

### PRIORITY CLAIM

This application is based upon and claims priority to U.S. provisional application Ser. No. 63/066,618, filed Aug. 17, 2020, incorporated fully herein by reference for all purposes.

### FIELD OF THE INVENTION

The invention pertains to waste treatment. More particularly, embodiments of this invention relate to the transfer, containment, stabilization and solidification of radioactive and/or hazardous waste.

### BACKGROUND OF THE INVENTION

It is sometimes necessary to transfer waste into containment devices. Transfer mechanisms frequently lack effective sealing of the material being transferred. The lack of an effective seal may lead to various problems.

Transfer mechanisms and sealing mechanisms often comprise a significant number of parts, leading to increased complexity in the design of these mechanisms. As the design of these mechanisms grows more complex, more parts may be used, leading to a potential increased risk of part failure, increased maintenance costs, and a more difficult installation process.

The process of solidifying radioactive waste is necessary to provide a suitable final waste form for disposal. The final waste form must meet certain criteria including low leach rates as well as high mechanical integrity and high resistance to irradiation. Many different shapes and sizes of receptacles can be used to meet these requirements. Cylindrical containers are typically a first choice due to their high-pressure retaining capabilities. However, other shapes may be preferred depending on the form of the final disposal site. Some containment devices have a poor design or strength that will not be able to retain heavy materials without deforming.

### SUMMARY OF THE INVENTION

One aspect of the embodiments described herein relates to a system for transferring material from a storage device to containers. The system may include a discharge chute having a mating surface that is configured to mate with a container. The discharge chute may configured to extend and retract so that the mating surface moves along a path between an extended position and a retracted position, and at least one controller may be used to cause the discharge chute to extend and retract. A portion of the discharge chute may move in a reciprocating manner in relation to another portion of the discharge chute.

Another aspect of the embodiments described herein relates to a containment assembly for use with radioactive materials. The containment box includes a container and a sealing lid with at least one locking pin. The container comprises a top face, and the top face comprises a cylindrical chamber opening where a sealing lid may be received. The cylindrical chamber opening comprises one or more pockets. The locking pins are configured to be received within the pocket of a cylindrical chamber opening track.

A further aspect of the present invention provides a method for operating a disposal system comprising providing a discharge chute. A drip-pan below the discharge chute is also provided. A container is located below the discharge chute and the drip-pan, wherein the discharge chute is in a retracted position. The drip-pan is moved so that it is not directly below the discharge chute. The discharge chute is extended downwardly to an extended position to form a seal with the container, wherein the drip-pan does not interfere with the extension of the discharge chute.

Another aspect of the present invention provides a method for operating a disposal system. The method involves providing a discharge chute and a container, wherein a seal exists between the discharge chute and the container. A drip-pan is also provided. The discharge chute is retracted upwardly to a retracted position. The drip-pan is moved below the discharge chute and above the container so that the drip-pan catches material falling from the discharge chute.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The embodiments of the present invention will become more fully understood from the detailed description and the accompanying drawings, which are not necessarily to scale, wherein:

FIG. 1 is a perspective view illustrating a disposal system and containers, in accordance with an embodiment of the present invention.

FIG. 2 is a perspective view illustrating a discharge chute and a container where the discharge chute is in a retracted position, in accordance with an embodiment of the present invention.

FIG. 3 is a perspective view illustrating the discharge chute and the container of FIG. 2 where the discharge chute is in an extended position.

FIG. 4 is a diagrammatic cross-sectional view of the discharge chute and the container of FIG. 3, in accordance with an embodiment of the present invention.

FIG. 5 is a perspective view illustrating another embodiment of a discharge chute and a container where the discharge chute is in a retracted position and where a pulley system is used, in accordance with an embodiment of the present invention.

FIG. 6 is a perspective view of the embodiment illustrated in FIG. 5 where the discharge chute in an extended position.

FIG. 7 is a perspective view illustrating a container where the external surfaces of the container are in phantom to reveal internal structures, in accordance with an embodiment of the present invention.

FIG. 8A is a perspective view illustrating a container, a final sealing lid, and a torque tool, in accordance with an embodiment of the present invention.

FIG. 8B is a diagrammatic cross sectional view illustrating a final sealing lid attached to a container, in accordance with an embodiment of the present invention.

FIG. 9 is a flow chart illustrating a method for transferring material from a discharge chute to a container, in accordance with an embodiment of the present invention.

FIG. 10 is a flow chart illustrating a method for retracting a discharge chute from a container, in accordance with an embodiment of the present invention.

FIG. 11 is a perspective view illustrating another embodiment of a discharge chute and a container where the discharge chute is in an extended position, in accordance with an embodiment of the present invention.

FIG. 12 is a side view of the embodiment illustrated in FIG. 11 where the discharge chute is in an extended position.

FIG. 13 is a perspective view of the discharge chute illustrated in FIG.

FIG. 14 illustrates a cross sectional view of the discharge chute illustrated in FIG. 13.

FIG. 14A illustrates an enlarged view of a portion of a cam-lock used in conjunction with the discharge chute of FIG. 14.

FIG. 15 is a side view illustrating a discharge chute in a retracted position, in accordance with an embodiment of the present invention.

FIG. 16 is a side view illustrating a discharge chute of FIG. 15 in an extended position.

FIG. 17 is a perspective view illustrating a container, in accordance with an embodiment of the present invention.

FIG. 18 is a block diagram illustrating an example system with various electronic devices, in accordance with an embodiment of the present invention.

### DESCRIPTION OF THE PREFERRED EMBODIMENTS

The following description of certain embodiments of the present invention is merely exemplary in nature and is in no way intended to limit the invention, its application, or uses.

A disposal system in accordance with the description herein may beneficially provide for the transfer of potentially radioactive and/or hazardous material into containers, with smooth transitions provided to maintain a relatively consistent boundary layer for the flow of materials. This may be accomplished by the use of a discharge chute that extends and retracts along a single axis. An inner lining may be provided in the discharge chute that may facilitate flow of material.

The disposal system may comprise a drip-pan, and the drip-pan may beneficially catch any droplets of material from the discharge chute when the discharge chute is in a retracted position. This drip-pan may be moved out of the path of the discharge chute before the discharge chute is extended to engage a container. The disposal system may comprise fluid-actuated (e.g., pneumatic) cylinders or other rotary or linear actuators to control the motion of the drip-pan and/or the discharge chute. Alternatively or in addition, the disposal system may comprise a pulley system to control the motion of a drip-pan and/or the discharge chute.

An ALARA (As Low As Reasonably Achievable) lid may advantageously be provided to cover the container while material within the container is undergoing a curing process. In some embodiments where grout is the material within the containers, the curing process is exothermic and results in the release of vapors. If these vapors are not ventilated, an increase in containment box pressure can result. A ventilation duct may be secured to the ALARA lid to allow for vapors to be removed from the container, so that the pressure within the container can be maintained at a desired level. This allows for an effective curing process and controls the internal pressure within the containers, preventing deformation of the container and leakage of the retained material. The ventilation duct for each container may be attached to an overhead trolley system on one end and an ALARA lid that is resting on the containment box on the other end so that the ventilation duct moves with the container while the container is being moved (e.g., driven down the track).

A containment assembly having a container and a final sealing lid is also provided, and this containment assembly also provides several advantages. The installment of a final sealing lid is simple and requires only the container and final sealing lid in some embodiments. The final sealing lid may comprise locking pins made of roundbar, e.g., ASTM A36 steel with a diameter of 0.25 inches. In some embodiments, the locking pins may comprise sheet metal. The container may comprise a cylindrical chamber opening where a sealing lid may be received, and the cylindrical chamber opening may comprise guide tracks defining a slight downward slope. A cavity may be defined at the top of the guide track where locking pins may be received, and pockets may be located at the end of the guide tracks. Upon being received within the cylindrical chamber opening, the locking pins can be positioned in the cavities at the top of the guide tracks. Then, a rotational force may be applied to the final sealing lid to rotate the locking pins underneath the guide track and into contact with the pockets so as secure the locking pins to the pockets. The downward normal force provided by the guide tracks and the pockets of the guide tracks may push the locking pins downward during this process, resulting in a tighter seal. Furthermore, the pockets may comprise a vertical lip or locking pocket that prevents the inadvertent re-opening of the sealed containment assembly. Thus, this final sealing lid and container may be used to form an effective seal so that radioactive and/or hazardous materials can be safely retained.

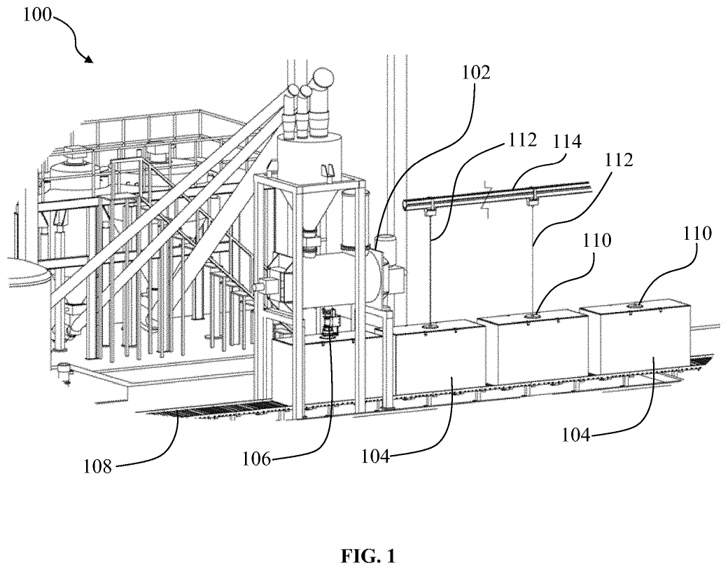

FIG. 1 illustrates an example disposal system 100. Disposal system 100 may comprise a storage component 102 which is the source of material that is introduced into a discharge chute 106. In some embodiments, the material held within storage component 102 is grout, and this grout may comprise radioactive and/or hazardous material.

The disposal system 100 may further comprise a guideway such as track 108 on which one or more containers 104 are located. This track 108 may comprise an external drive conveyor mechanism that moves the containers 104 along the track 108 in intermittent fashion until each is positioned underneath the discharge chute 106. The discharge chute 106 may be directly or indirectly secured to the storage component 102, and the discharge chute 106 may extend and mate to the container 104 so that a seal may be formed. At this position, the container 104 may receive material from the discharge chute 106. Once a certain amount of material is supplied into a container 104, the discharge chute 106 can be retracted and the container 104 may move down the track 108 (towards the right in FIG. 1).

The container 104 may remain on the track 108 during a curing process. An ALARA lid 110 may be installed to cover or seal the container 104 during this curing process, and a duct 112 may be attached to this ALARA lid 110. The duct 112 may assist in maintaining the material within the container 104 at the correct pressure and may also assist in sealing the ALARA lid to the container. The duct 112 may be connected on one end to a trolley system 114 so that the duct 112 may shift with the associated container 104 as the container moves along the track 108. Once the curing process is complete, a final seal may be implemented on the container 104.

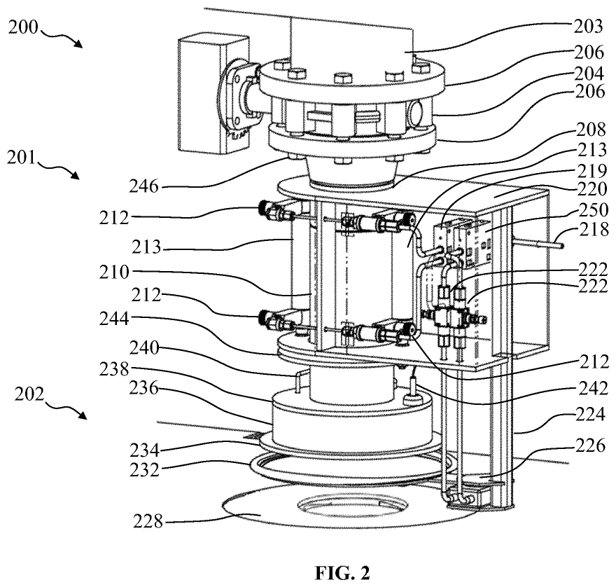

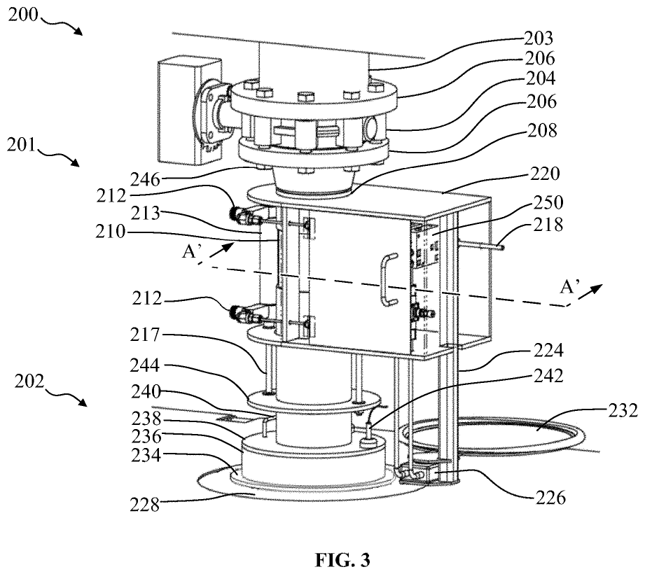

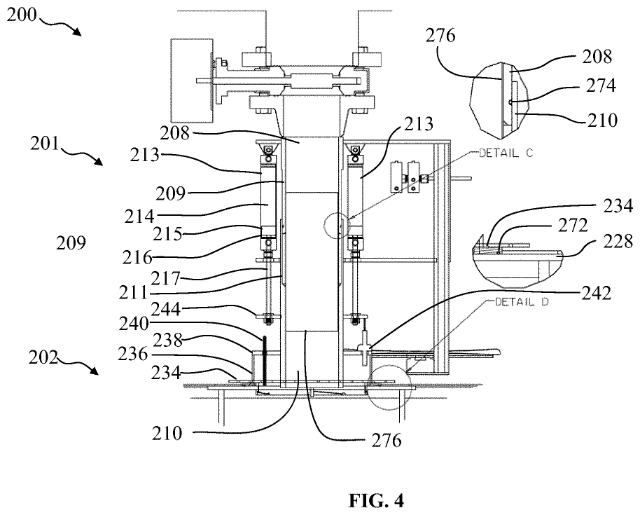

FIG. 2 illustrates an example discharge chute in a retracted position. FIG. 3 illustrates the discharge chute of FIG. 2 in an extended position. FIG. 4 illustrates a diagrammatic cross-sectional view of the discharge chute presented in FIG. 3 about the line A′-A′.

Referring now to FIG. 2, a disposal system 200 comprises a discharge chute 201 positioned above a container (shown partially) into which material is to be supplied. The discharge portion 203 of a storage component (which may be similar to storage component 102 of FIG. 1) may introduce a supply of the material. A flow valve 204 may be positioned between the discharge portion 203 and first tubing 208 of the discharge chute 201. Flow valve 204 may be opened to permit the flow of material from the storage component to the first tubing 208 or closed to block this flow. The flow valve 204 may be manually opened or closed in some embodiments, or may be electrically actuated, pneumatically actuated, etc. In this case, the flow valve 204 may receive electric signals so as to open/close under specified conditions.

The first tubing 208 has a generally cylindrical shape in the embodiments illustrated in FIGS. 2-4, but may have different shapes in other embodiments. The first tubing 208 may be static, such as being directly or indirectly anchored to the discharge portion 203. This may be accomplished through the use of one or more flanges 206, adhesives, and/or other fasteners. The connection will preferably be strong enough to withstand the weight of other components and material that may be present within the other components. In the embodiment illustrated in FIGS. 2-4, flanges 206 may be ASME B16.5 flanges or another similar flange, and bolts 246 may be used to assist in securing the first tubing 208 to the storage component 203. However, other flanges or connection mechanisms may also be utilized as appropriate.

As shown in FIG. 4, the first tubing 208 may comprise a first portion 209 with a reduced external perimeter (e.g., external circumference) relative to other portions of the first tubing 208. The reduced external perimeter/circumference of the first portion 209 may be created by removing material from that portion of the first tubing 208. The removal of material may allow for a controlled surface finish with the surface finish having a sufficiently low roughness to reduce wear that might otherwise occur at sealing O-ring(s) 274. This first portion 209 may be positioned towards the bottom of the first tubing 208.

FIGS. 2-4 also illustrate a second tubing 210. The second tubing 210 has a generally cylindrical shape in the embodiments illustrated in FIGS. 2-4, but may have different shapes in other embodiments. This second tubing 210 may be dynamic in that the second tubing 210 may move vertically with respect to the first tubing 208. The second tubing 210 may comprise a second portion 211 with an increased internal perimeter or internal circumference relative to other portions of the second tubing 210. The increased internal perimeter/circumference of the second portion 211 of the second tubing 210 may be created by removing material from that portion. As shown in FIG. 4, this second portion 211 may be positioned towards the top end of the second tubing 210. The inner perimeter or circumference of the second portion 211 of the second tubing 210 may define a recess through which the first portion 209 of the first tubing 208 may be telescopically received. The lengths of the first portion 209 and the second portion 211 may be approximately the same, and these lengths will preferably be greater than the maximum displacement of the second tubing 210. The second tubing 210 may be extended or retracted in a reciprocating manner. In this embodiment, first tubing 208 and second tubing 210 may be formed from 300 Series stainless steel, and this steel may be provided as a 4-inch pipe or a 0.5-inch-thick rolled plate.

In the embodiment illustrated in FIGS. 2-4, pistons and control valves are provided. The cylinders are fluid-actuated, e.g., pneumatic, in this case. (One skilled in the art will appreciate that other types of linear actuators, e.g., linear motors or various pulley systems, could be utilized in some embodiments.) As shown in FIG. 4, a piston 213 may comprise a first chamber 214, a piston head 215, and a second chamber 216. First chamber 214 may be provided above piston head 215 and second chamber 216 may be provided below piston head 215, and these chambers may each hold and receive fluid (e.g., gases or liquids). Pistons 213 may be used to cause movement of the second tubing 210 with respect to first tubing 208. In this regard, the piston 213 may possess a first side that may remain static relative to the first tubing 208, and this may be accomplished by securing the first side of the cylinder to the first tubing 208 either directly or indirectly. In the example provided in FIGS. 2-4, the first side of the piston 213 is secured to the first tubing 208 by a plate and fasteners. A second side of the piston 213 may be secured to second tubing 210 either directly or indirectly. In FIGS. 2-4, a plate 244 is welded to the second tubing 210, and a rod 217 connected to the piston head 215 may be secured to that plate using one or more fasteners.

When fluid is supplied to the first chamber 214, the pressure within the first chamber 214 will increase, and the volume of the first chamber 214 will begin to increase by a certain amount due to movement of the piston head 215. The total amount of fluid in the first chamber 214 and the second chamber 216 may remain approximately the same so that a corresponding amount of fluid is removed from one chamber when fluid is introduced to the other chamber. As the volume of the first chamber 214 increases, piston head 215 will move within the cylinder. In the example provided in FIGS. 2-4 where the piston head 215 is oriented to move vertically, the piston head 215 will move down. Because rod 217 of the piston 213 is secured, directly or indirectly, to the second tubing 210, the second tubing 210 will also shift downwardly. (As explained below, embodiments are contemplated in which downward shift is due solely to gravity.) By controlling the amount of fluid material introduced to and evacuated from each chamber, the second tubing 210 is extended so that it may come into contact with a container 202 locating below the second tubing 210.

In this embodiment, the second tubing 210 is retracted by pistons 213. Specifically, by increasing the amount of fluid in the second chamber 216 and decreasing the amount of fluid in the first chamber 214, the piston head 215 moves upwardly. The rod 217 thus exerts an upward force on the second tubing 210. As this piston 213 is retracted, the second tubing 210 will also begin to retract until the second tubing 210 reaches the retracted position shown in FIG. 2.

In the embodiment illustrated in FIGS. 2-4, air is used as the fluid within the system that actuates piston 213. Air may be supplied via an air supply 218. Air from the air supply 218 may be provided to a piston air control unit 219, which may comprise one or solenoid valves. This piston air control unit 219 may be used to receive sensor values to obtain data about position of the second tubing 210, to process that data to determine the appropriate amount of air to supply to lines, and to supply the appropriate amount of air to the lines. The piston air control unit 219 may also determine when and how air is allowed to vent from the chambers.

A housing 220 may be secured directly or indirectly to the first tubing 208. This housing 220 may hold various components and may assist in protecting the components. For example, FIG. 2 illustrates valves 212, 222 and air control units 219, 250 within this housing 220. While a housing 220 is depicted in FIG. 2, other embodiments may not comprise a housing 220, and components within the housing 220 may be positioned outside of the housing 220 in other embodiments.

Control valves 212 may allow for the flow of fluid to be adjusted. Specifically, control valves 212 may adjust the rate of pressurization on either side of the piston head 215 to ensure that the instantaneous acceleration of the piston head 215 is not too high. By maintaining the motion of the piston head 215 in a controlled manner, the control valves 212 may help protect various components from damage such as the first tubing 208, the second tubing 210, the container 202, etc.

The second tubing 210 may comprise an enlarged portion 236, and this enlarged portion 236 may have an enlarged external circumference or perimeter relative to other portions of the second tubing 210 positioned above the enlarged portion 236. The internal circumference or perimeter within the enlarged portion 236 may remain the same as the internal circumference or perimeter within other portions of the second tubing 210.

An instrument plate 238 may rest above this enlarged portion 236, and the instrument plate 238 may be welded or otherwise suitably attached to the second tubing 210 in some embodiments. Various components may be affixed to the instrument plate 238. For example, pressure relief tubing 240 may be affixed to the instrument plate 238. Pressure relief tubing 240 may be used to maintain the pressure within the system 200 and/or the container 202 at a desired level by venting internal pressure from the system 200 and/or the container 202.

One or more proximity sensors may also be affixed to the instrument plate 238, and the proximity sensor(s) may be used to detect the position of the second tubing 210. A level switch/sensor 242 may also be affixed to the instrument plate 238 such that the level sensor 242 is immersed upon full extension when a container 202 has been filled with material. However, in some embodiments, a laser level sensor may be used, and this may avoid contact between the level sensor and the material in the container. Additionally, the enlarged portion 236 may comprise a mating flange 234 at the free end of the enlarged portion 236. This mating flange 234 is shown at the bottom of the enlarged portion 236 in FIGS. 2-4.

As illustrated in FIG. 4, at the bottom surface of the mating flange 234, a small recess may be formed where an O-ring 272 may be received. This O-ring 272 may remain secured within the small recess so that the O-ring 272 remains static relative to the enlarged portion of the second tubing 210. The use of an O-ring 272 may allow the bottom surface of the mating flange 234 of the second tubing 210 to seal with the mating flange 228 of the container 202. Additionally, one or more O-rings may be provided on the mating flange 228 of the container 202.

A drip-pan 232 may also be provided to catch material that may fall from the discharge chute 201 after it has been retracted. In some embodiments, the drip-pan 232 may comprise a stainless-steel disposable tray layered with superabsorbent and covered with a cloth-like material. In the embodiment illustrated in FIGS. 2-4, the drip-pan 232 has a permanent frame with a drip-pan liner secured over the frame that can be disposed and replaced. However, in other embodiments, the drip-pan 232 may be formed by the same material throughout, and the drip-pan 232 may also be formed be a variety of other materials.

A support beam 224 may be secured to the housing 220. The pivot point of the drip-pan 232 may be secured to the support beam 224 or to the drip-pan control table 226 so that the drip-pan 232 does not move vertically. However, the pivot point of the drip-pan 232 may move vertically in some embodiments.

Drip-pan control table 226 may be provided proximate to the drip-pan 232 near the bottom end of the support beam 224. The drip-pan 232 may move below the discharge chute 201 when the discharge chute 201 is in a retracted position (as shown in FIG. 2). As shown in FIG. 3, the drip-pan 232 may move out of the path of the discharge chute 201 as the discharge chute 201 extends to allow the discharge chute 201 to come into contact with the container 202. Movement of the drip-pan 232 may also be induced before the discharge chute 201 is lowered.

In the embodiment depicted in FIGS. 2-4, the drip-pan 232 rotates about a pivot point. The movement of the drip-pan 232 may be generated by one or more fluid-actuated (e.g., pneumatic) cylinders, and the drip-pan control table 226 may control this movement in some embodiments. For example, compressed air may be supplied to one side of the drip-pan control table 226 which moves a rack and pinion mechanism to incite rotational motion of the drip-pan 232. To create the reverse motion, air may simply be supplied to the other side of the drip-pan control table 226. Air may be vented from one of the two sides of the drip-pan control table 226 to also control the rotational motion of the drip-pan 232. The rotational movement of the drip-pan 232 may be electronically correlated with the vertical motion of the discharge chute 201 so that the discharge chute 201 and the drip-pan 232 do not come into contact with each other. While the drip-pan 232 rotates about a pivot point in the embodiments depicted in FIGS. 2-4, embodiments are contemplated in which the drip-pan 232 moves in other directions (e.g., a straight line) to clear the extended discharge chute. Preferably, location feedback for the drip-pan may be interlocked to a flow valve in the discharge chute 201 and to piston air control unit 219, and actions may occur in series.

FIG. 3 shows the example discharge chute 201 with the second tubing 210 in a fully extended position. When the drip-pan 232 is out of the way, the second tubing 210 may be lowered so that the mating flange 234 of the second tubing 210 may come into contact with the mating flange 228 of the container 202. By applying a downward force at the mating flange 234 of the second tubing 210, a seal may be formed between the two mating flanges.

Air from the air supply 218 may be provided to a drip-pan air control unit 250. This drip-pan air control unit 250 may be used to receive sensor values to obtain data about position of the drip-pan 232, to process that data to determine the appropriate amount of air to supply to one or more lines, and to supply the appropriate amount of air to the one or more lines. The drip-pan air control unit 250 may also determine when and how to vent air from the drip-pan control table 226.

The seal formed between the mating flange 234 of the second tubing 210 and the mating flange 228 of the container 202 will preferably be able to withstand some internal pressure resulting from filling the container 202. To accomplish this, a downward sealing force may be provided, and in some embodiments, this force is provided by the mating flange 234 of the second tubing 210. In addition, to assist in proper sealing, the bottom face of the mating flange 234 of the second tubing 210 may have a sufficiently low surface roughness to ensure full contact sealing. The bottom face of the mating flange 234 may define a recess where O-ring(s) 272 may be received, and the surfaces within this recess may also have a low surface roughness.

The internal pressure will preferably be low to prevent O-ring blow-out when a low surface roughness is used. However, pressure levels and surface roughness may vary in other embodiments. To achieve low pressure, pressure relief tubing 240 or some other ventilation element may be used. The pressure relief tubing 240 may comprise a length of tubing that interfaces at the instrument plate 238 with one end inside the receptacle and the other side going to a filter. The filter may prevent undesired materials from escaping while allowing vapors to be released. This pressure relief tubing 240 may safely lower the internal pressure when necessary to prevent too much internal pressure from building up within the system 200 and/or the container 202. High internal pressure may lead to unseating of faces or expulsion of contained material.

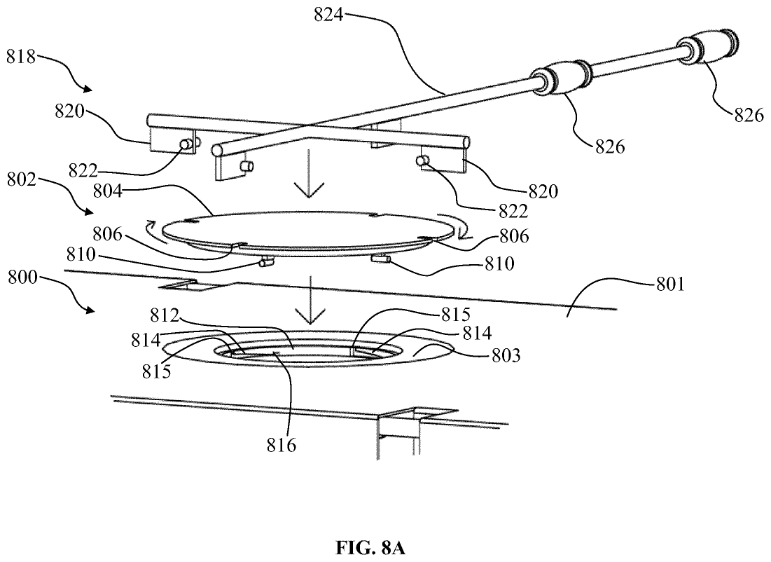

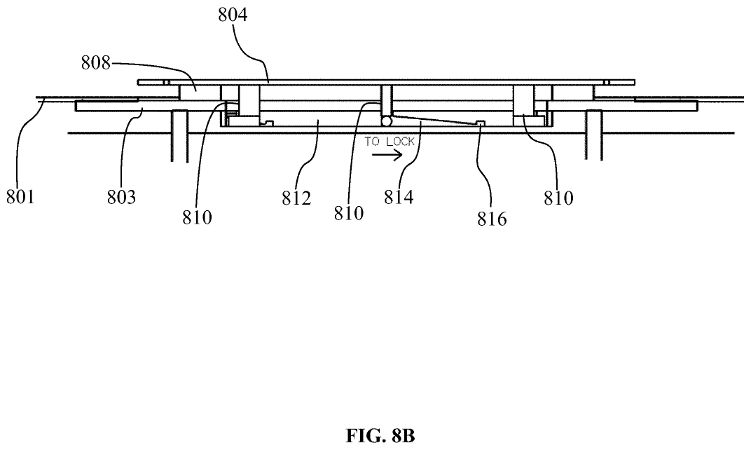

Once the mating flanges 228, 234 are properly sealed, a sensor may signal a controller, and the controller may cause the flow valve 204 or another valve to open so that the material is allowed to flow through the discharge chute 201 and into the container 202. This sensor may take the form of a proximity sensor, and the proximity sensor may confirm that engagement between the mating flanges 228, 234 has formed a seal. Material may flow down from the discharge chute 201 and into the container 202 until the container 202 is filled to a prescribed level. In one embodiment, container 202 is filled until the container 202 has been filled up to approximately an inch and a half from the top face (801, FIG. 8B) of the container 202. The level of material within the container 202 may be determined in a variety of ways. For example, a sensor may be used to detect the level of the material within the container 202, the level of material within the container 202 can be calculated based on the volume of the container 202 and the flow rate of material from the discharge chute 201, etc.

Once the container 202 is filled to its prescribed level, the flow valve 204 or another valve within the system may close to prevent the flow of excessive material into the container 202. The discharge chute 201 may then be retracted, and the material within the container 202 may undergo a curing process. Referring again to FIG. 1, the containers 104, 202 may be guided during the curing process by an external drive conveyor system down a track 108. This track 108 allows the material to sit while successive containers 104, 202 are being filled to provide a steady process flow. Grout may frequently be the material that is transferred into the containers 104, 202, and the curing of the grout is an exothermic process that can release vapors upon heating. Therefore, after the filling of the container 104, 202, an ALARA lid 110 with an attached duct 112 may be placed over the opening of the container 104, atop the container mating flange. This ALARA lid 110 may be engineered to have enough downward force (e.g., due to its weight) to contain vapors released from the exothermic process. In some embodiments, duct 112 may provide a vacuum suction to assist with forming a seal of ALARA lid 110. The duct 112 for each container may be attached to a rolling trolley system 114 such that the duct 112 moves with the container 104 while the container 104 moves down the track 108. Once the curing is complete, the ALARA lid 110 may be removed for the final closing of the container 104.

FIG. 4 also illustrates the interface between the first tubing 208 and the second tubing 210. A wall of the first tubing 208 may be positioned inside of a wall of the second tubing 210, and these two walls may be in contact with each other. An O-ring 274 may be secured between the wall of the first tubing 208 and the wall of the second tubing 210. (In some embodiments, an O-ring may not be used.) In the embodiment depicted in FIG. 4, a portion of the material within the wall of the first tubing 208 may be removed about the external perimeter to form a recess where the O-ring 274 may be received. However, in other embodiments, this recess may be formed along the internal perimeter of the second tubing 210 and the O-ring 274 may be received within that recess. The O-ring 274 may create a seal between the first tubing 208 and the second tubing 210 so that the internal pressure within the system 200 may be maintained.

In transfer of aqueous radioactive wastes, “hot-spots” or tight angles are preferably avoided to prevent any boundary layer disruption in flow that permits particulate to accumulate in the crevices. Therefore, maintaining smooth transitions with no drastic changes in internal circumference or perimeter may be beneficial. An inner lining 276 may assist in maintaining these smooth transitions by providing a small transition thickness. Inner lining 276 may also protect the seal from contaminants, e.g., preventing contaminants from entering the interface between the first tubing 208 and the second tubing 210. The inner lining 276 will preferably be large enough vertically to protect the interface between first tubing 208 and second tubing 210 when the second tubing 210 is in a fully extended position.

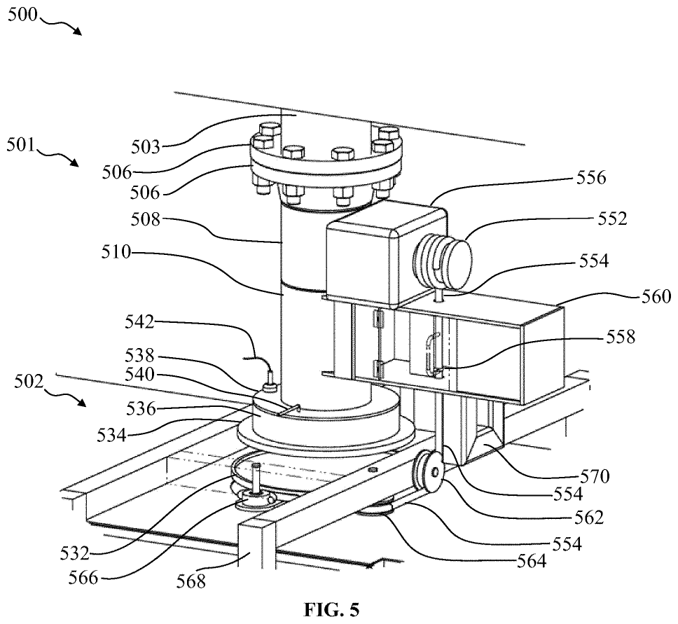

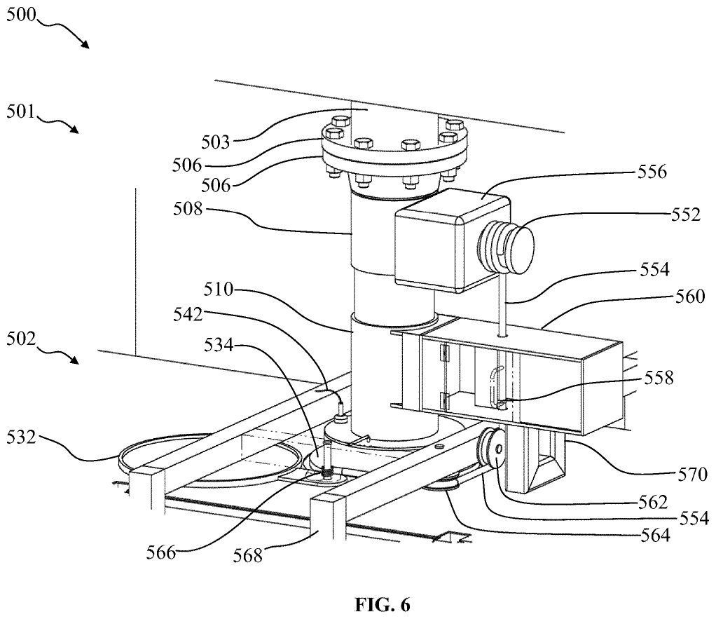

FIG. 5 illustrates a second example discharge chute 501 in a retracted position. FIG. 6 illustrates the discharge chute 501 of FIG. 5 in an extended position. The system 500 presented in FIGS. 5-6 utilizes pulleys to adjust the position of the discharge chute 501. Where a pulley system is utilized, the motion of the second tubing 510 in the downward direction may be caused at least partially by the force of gravity, and the motion of the second tubing 510 in the upward direction may be provided by a tension force from a connected cable. A winch 552 may be utilized to generate a tension force within a connected cable 554, and this winch 552 may be secured directly or indirectly to the first tubing 508. This winch 552 may be an electric winch and may also be driven by a motor 556. However, other power sources may be utilized.

A cable anchor attachment 558 may be secured directly or indirectly to the second tubing 510. In some embodiments where this pulley system is used, the length of cable released or retracted by the winch 552 may be equal to the displacement of the second tubing 510. In FIGS. 5-6, the cable anchor attachment 558 is connected to the counterweight attachment 560, which is in turn connected to the second tubing 510. As the winch 552 pulls or releases the cable 554, the cable anchor attachment 558 may rise or fall, and the second tubing 510 may therefore rise or fall with the cable anchor attachment 558.

As the second tubing 510 of the discharge chute 501 descends, the drip-pan 532 is allowed to rotate out of the downward path of the second tubing 510. The tensile force from a cable in the pulley system may cause this rotational movement of the drip-pan 532. For example, FIG. 5 shows the drip-pan 532 in a first position that is underneath the discharge chute 501. In FIG. 5, the cable 554 extends from the winch 552, extends through the counterweight attachment 560 and through the pulleys 562, 564, and is secured to a torsion spring 566. The winch 552 may generate a tensile force that will act on the cable 554, and this tensile force may be effectively transferred to act upon the torsion spring 566, causing the drip-pan 532 to rotate to the first position underneath the discharge chute 501 (as depicted in FIG. 5). At this first position, the torsion spring 566 may propagate tension to the cable 554.

As shown in FIG. 5, the direction of the tensile force may be controlled by the orientation of two interconnected pulleys 562, 564, which both have pivot anchor points on the supporting structure 568. As the second tubing 510 of the discharge chute 501 is being lowered, the drip-pan 532 may rotate to a second position out of the downward path of the second tubing 510 (as depicted in FIG. 6). This change in position may be generated by either raising or lowering the tensile force generated by the winch 554.

For the embodiment shown in FIGS. 5-6, counterweight attachment 560 may comprise a counterweight to maintain a dynamic moment balance. The counterweight attachment 560 may prevent unwanted rotation in the system 500. The counterweight attachment 560 may also prevent rotation at the sealing interface to ensure a proper seal between the mating face 534 of the second tubing 510 and the mating face 528 of the container 502. A counterweight crutch 570 may be included to provide additional support for the counterweight attachment 560.

While the drip-pan 532 is shown to rotate from a first position to a second position and vice versa in FIGS. 5-6, pulleys may also be used to cause linear movement or other types of movement. Drip-pan 532 and torsion spring 566 may be connected instead to support structure 568.

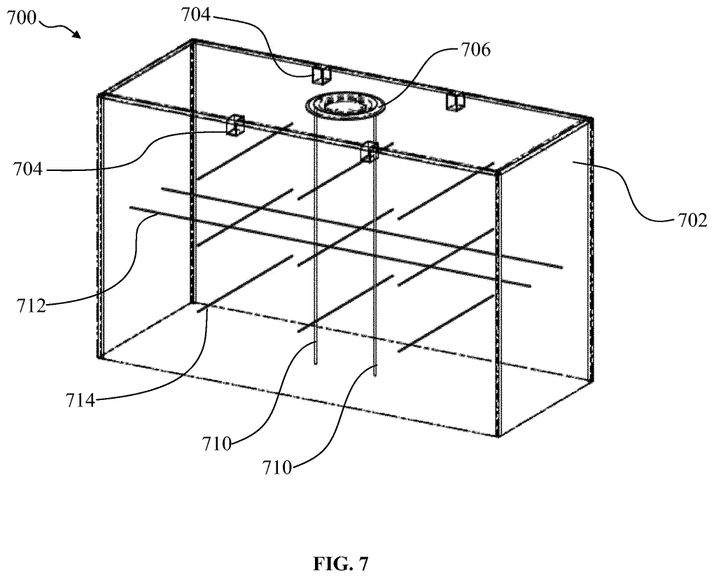

FIG. 7 shows an example container that may receive material from a discharge chute as described above. Container 700 (which is analogous to other containers discussed herein) may come in a variety of shapes and/or sizes. For example, the container 700 may be generally rectilinear, cylindrical, spherical, etc. In an embodiment, container 700 may have the shape of a rectangular box, e.g., a length of 88 inches, a width of 36 inches, and a height of 53½ to 53¾ inches. These dimensions are suitable for efficient packing in final disposal container volumes. Specifically, these dimensions are particularly beneficial because they allow for six containers 700 to be placed in a single Modular Concrete Canister (MCC), which is used for Class B & C waste at WCS. Thus, by utilizing containers 700 with the dimensions described above, the usable volume in the MCCs may be maximized. The container 700 may also comprise a variety of materials, and will preferably be rigid. In an embodiment, the container 700 may be constructed of carbon steel material, and the container may be made from sheet metal in some embodiments.

The container 700 may comprise a mating flange 706. The mating flange 706 on the container 700 may have a suitable surface finish to allow for a proper seal. This may be done by reducing the surface roughness of this mating flange 706. In addition, the container 700 may be strengthened by several supports, here in the form of bars 710, 712, 714. These bars 710, 712, 714 may provide additional structural support to the container 700 so that the container 700 may maintain its shape, and the supports 710, 712, 714 may enable the container 700 and the mating flange 706 to withstand pneumatic sealing forces and gravitational forces. In the embodiment shown in FIG. 7, two lengthwise bars 712 are provided, two vertical bars 710 are provided, and nine lateral bars 714 are provided. However, a different number of supports may be provided in other containers, and the supports may have a different orientation or shape in other embodiments. As shown in FIG. 7, the support bars may be positioned on each side of the mating flange 706. However, one or more supports may be utilized to provide support directly to the mating flange 706, and the supports may be positioned at different locations than the locations in which they are shown in FIG. 7. The supports may be designed to withstand internal pressure on all inner surfaces of the container 700 up to at least 3 psi.

The container 700 may also comprise lifting pockets 704 in the form of recesses within the container 700 where a lifting mechanism can be deployed to lift the container 700. A lifting bar may also be provided above the lifting pockets 704 in some embodiments to further assist in lifting the container, and the lifting bar may provide additional support to the container.

FIG. 8A illustrates an example container 800 and a final sealing lid 802 that may be used to seal the container 800. FIG. 8B illustrates a cross-sectional view through the centerline of the final sealing lid 802 located on the container 800.

FIG. 8A illustrates a top face 801 of the container 800 with a mating face 803. The mating face 803 may be positioned below the top face 801, above the top face 801, or coplanar with the top face 801. The thickness of the mating face 803 is greater than the thickness of the rest of the top face 801 in FIG. 8A, but the thicknesses may vary in other embodiments.

The final sealing lid 802 may comprise a top plate 804, and this top plate 804 may have one or more notches 806. These notches 806 may define recesses within the top plate 804 where inserts 820 of a torque tool 818 may be received. The final sealing lid 802 may also comprise one or more gaskets 808 (FIG. 8B), and one or more locking pins 810. Gaskets 808 may assist in forming a seal between the final sealing lid 802 and the container 800. This gasket 808 may, for example, comprise a PTFE gasket. The locking pins 810 may comprise sheet metal, but plates, bars, and other appropriate shapes may also be used. In the embodiment shown in FIGS. 8A and 8B, the locking pins 810 may comprise a cylindrical pin at the free end of the locking pin 810, and this cylindrical pin may have an increased thickness compared to other portions of the locking pin. However, the locking pin 810 may comprise a different design in other embodiments.

A guide cylinder 812 may be provided within container 800. The guide cylinder 812 may define a recess where an ALARA lid or the final sealing lid 802 may be received. This guide cylinder 812 may comprise one or more guide tracks 814, and these guide tracks may have a downward incline. In the embodiment shown in FIG. 8A, this downward incline occurs in a clockwise manner so that the elevation of the guide tracks 814 decreases along the clockwise direction. A cavity 815 may be defined at the top of the guide track 814 where locking pins 810 may be received so that locking pins 810 may move underneath the guide track 814. The guide cylinder 812 may comprise a pocket 816 at the end of each guide track 814, and these pockets 816 may define recesses where the locking pins 810 or the cylindrical pin of the locking pins 810 may be received. In one embodiment, the distance from the pockets 816 to the top face 801 of the container 800 may be approximately a quarter of an inch.

To begin the final sealing, the final sealing lid 802 should be rotated to the correct angular orientation so that the locking pins 810 are placed within the cavities 815 of the guide tracks 814. Where rigid locking pins 810 are used, the final sealing lid 802 may be rotated, and the rigid locking pins 810 may generally refrain from bending. The locking pins 810 may comprise a cylindrical pin with a greater thickness than the remainder of the locking pin. As the final sealing lid 802 rotates, the cylindrical pin may shift underneath the guide track 814 with the guide track 814 exerting a downward force on the cylindrical pin. This downward force may result in compression on the gasket 808. The final sealing lid 802 may then be rotated until the locking pins 810 enter pockets 816 formed within the container 800.

Pockets 816 are positioned at the end of the guide track 814. Pockets 816 may be slightly elevated from other portions near the end of the guide track 814 so that the pockets 816 have a vertical lip. This vertical lip may assist in preventing the final sealing lid 802 from being easily twisted back off in the opposite direction, preventing the inadvertent re-opening of the sealed containment box. These pockets 816 may be machined out of the container 800. By securing the locking pins 810 within the pockets 816, the pockets 816 may provide a normal force that will retain the final sealing lid 802 and the gasket 808 in a secure position. The final sealing lid 802 may become sealed with the container 800 so that they may together form a containment box.

In some embodiments, as downward force is applied to the final sealing lid 802, the locking pins 810 may bend. Bending of the locking pins 810 in the correct direction may be induced in a variety of ways. For example, an additional inclined track, fillet, chamber etc. may be provided underneath the cavity 815 so that a normal force acting on the locking pin 810 will push the locking pin 810 in the desired direction. Additionally, the locking pins 810 may be designed so that they initially are tilted at a slight angle from an upright position; as the final sealing lid 802 is pushed downward, this angle may increase. However, the bending of locking pins 810 in the correct direction may be induced in other ways. Furthermore, the locking pins 810 may generally refrain from bending in other embodiments, as described above.

A torque tool 818 may be applied to the final sealing lid 802 to provide a rotational force and/or a downward force to the final sealing lid 802. The torque tool 818 may comprise one or more inserts 820, and these inserts 820 may comprise a key-like shape. The torque tool 818 depicted in FIG. 8A comprises inserts 820 at four equally spaced-apart positions. These inserts 820 may be received within the notches 806 of the top plate 804 of the final sealing lid 802, and then a force may be applied to rotate the torque tool 818 in the clockwise or counterclockwise direction. The inserts 820 may comprise pegs 822. The pegs 822 may rest on the top surface of the top plate 804 of the final sealing lid 802 when the torque tool 818 is being used, and this allows a user to more easily apply a downward force while using the torque tool 818 if necessary. The torque tool 818 may comprise a long outward stretching moment arm 824, and grips 826 may be positioned at locations along the moment arm 824. By including this moment arm 824, the torque generated by using the torque tool 818 can be increased and the container 800 may be more easily accessible from a distance so that a user can easily secure the final sealing lid 802. When the torque tool 818 is twisted, the final sealing lid 802 and locking pins 810 twist as well. This torque tool 818 may allow a user to manually secure the final sealing lid 802. However, in other embodiments, a machine or automation may secure the final sealing lid 802 without manual input.

The final sealing lid 802 may advantageously be applied when the container 800 is on the track (FIG. 1, 108). This allows for a streamlined process for improved efficiency. Additionally, the final sealing lid 802 may advantageously form an effective seal without using a large number of parts. This is advantageous because the final sealing lid 802 is therefore simpler to install and because there are fewer parts that could potentially fail to prevent an effective seal.

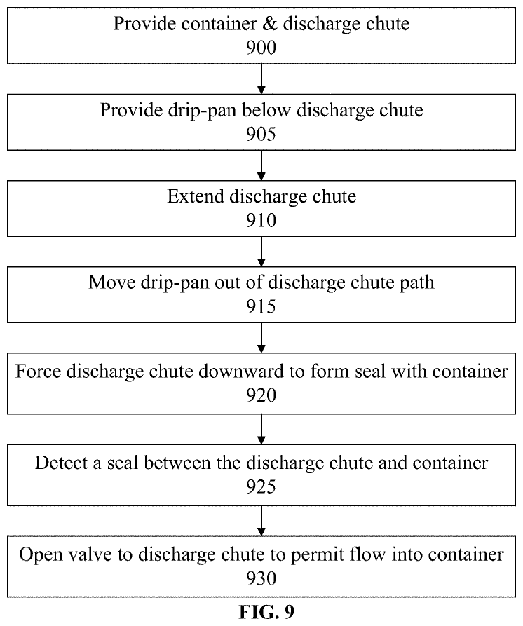

FIG. 9 illustrates an example method that may be performed to store material in a container. At step 900, a container and a discharge chute may be provided with the discharge chute being positioned in a retracted position and with the container positioned below the discharge chute. In some embodiments, step 905 may be performed and a drip-pan may be provided, with the drip-pan being placed at a first position underneath the discharge chute. At step 910, the discharge chute is extended. The discharge chute may be extended to come into contact with the container. This extension may occur by causing a piston to shift to an extended position where a piston assembly is used. Alternatively, this extension may occur by increasing or decreasing a cable tension where a pulley system is used. At step 915, the drip-pan may be moved to a second position out of the downward path of discharge chute so that the drip-pan is not directly below the discharge chute and so that the discharge chute may move into an extended position. For example, the drip-pan may move out of the discharge chute's path as the discharge chute is in the process of descending or just prior to the descent of the discharge chute. Notably, step 915 may be performed before or simultaneously with step 910. At step 920, the discharge chute may be forced downward to exert a downward force on the container, and this force may assist in forming a seal with the container below. The drip-pan will be out of the downward path of the discharge chute so that the drip-pan does not interfere with the extension of the discharge chute. After this seal has been formed, a proximity sensor may be utilized to detect the seal at step 925. At step 930, material is allowed to flow from the discharge chute to the container. For example, in some embodiments, a flow valve is provided upstream of the discharge chute that is configured to permit or inhibit flow of material into the discharge chute. This flow valve may be opened to permit flow of material into the discharge chute.

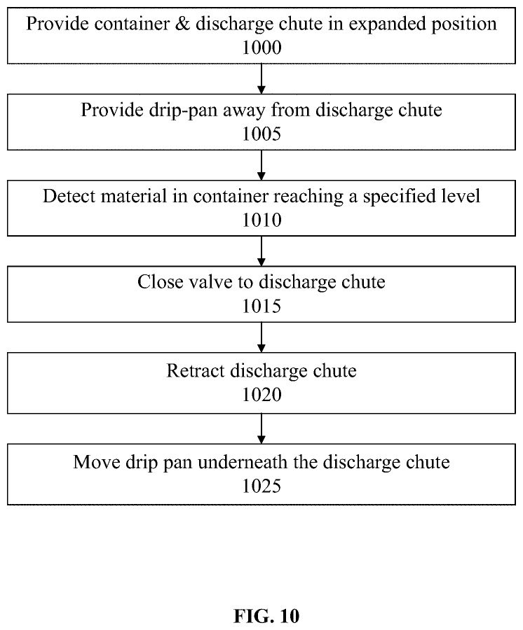

FIG. 10 illustrates various steps that may be taken to retract a discharge chute from a container. At step 1000, a container and a discharge chute may be provided with the discharge chute being positioned in an extended position and with a seal being formed between a mounting plate of the container and a mounting plate of the discharge chute. The discharge chute may be filling a container with material. In some embodiments, step 1005 may be performed so that a drip-pan is provided at a second position away from the discharge chute. The drip-pan preferably will not interfere with or contact the discharge chute in this second position. At step 1010, a level sensor may detect when the level of the material within the container exceeds a specified level. Once the level sensor detects material at a specified level, a signal may be transmitted at step 1015 to close a flow valve via which material is fed to the discharge chute. (A flow sensor may be used in place of a level sensor in some embodiments). Once the valve is closed, the discharge chute may then be retracted at step 1020. This retraction may occur as a result of a piston shifting to a retracted position where a piston assembly is used. Alternatively, this retraction may occur by increasing or decreasing a cable tension where a pulley system is used. At step 1025, the drip-pan may be moved underneath the discharge chute and above the container when the discharge chute retracts. This movement may occur after the discharge chute is fully retracted, or the movement of the drip-pan may occur while the discharge chute is being retracted.

While various steps are illustrated in FIGS. 9 and 10, it should be understood that additional steps may be performed, or some of the illustrated steps may be omitted. Additionally, the steps may be performed in different orders, and steps may be performed simultaneously in some embodiments.

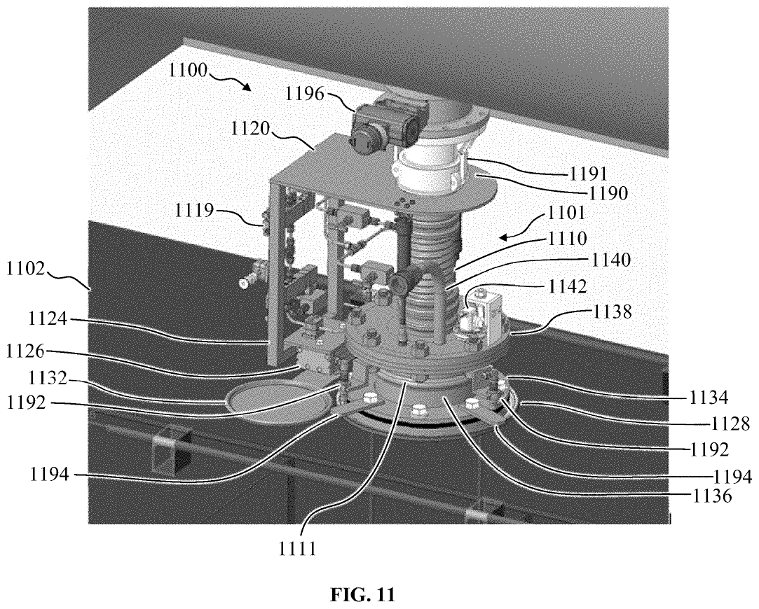

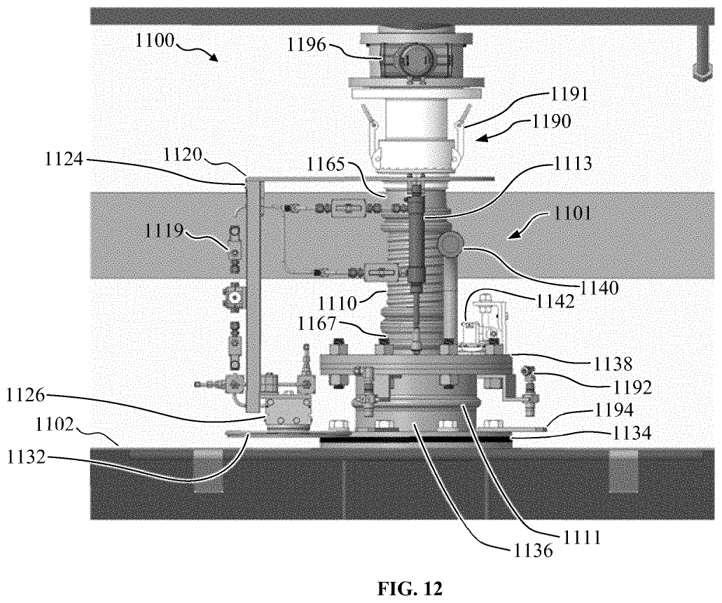

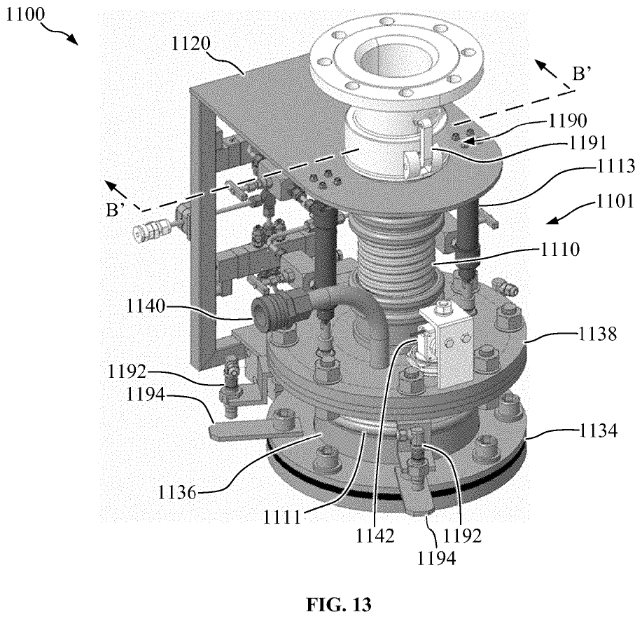

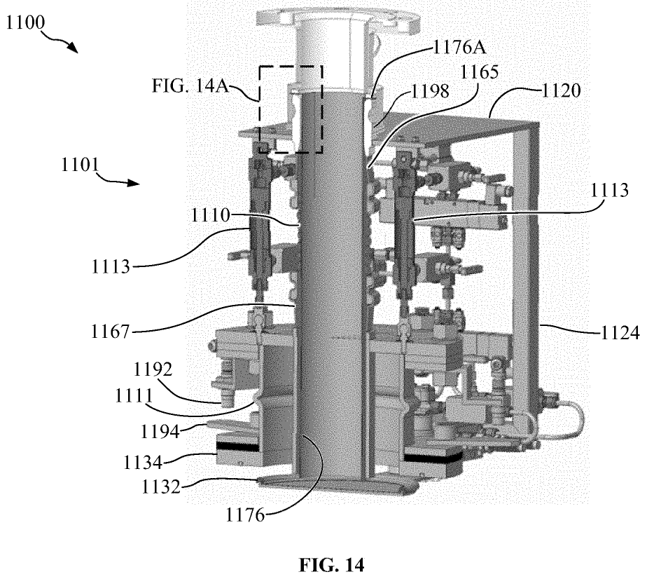

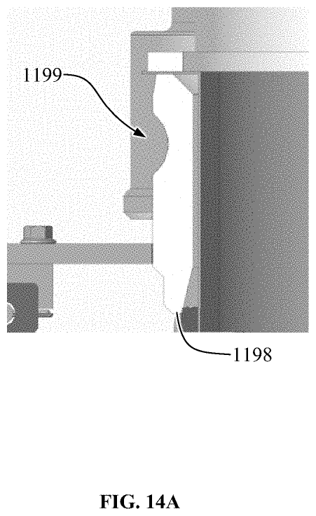

Other discharge chute embodiments may also be provided using a flexible coupling (e.g., bellows type) between rigid upper and lower tubing rather that telescopic rigid tubing as discussed above. FIGS. 11-14 and FIG. 14A illustrate an example disposal system 1100. FIG. 11 is a perspective view of a discharge chute 1101 and a container 1102 where the discharge chute 1101 is in an extended position. FIG. 12 is a side view of the embodiment illustrated in FIG. 11, FIG. 13 is a perspective view of the discharge chute 1101 of FIG. 11, FIG. 14 is a cross sectional view of the discharge chute 1101 of FIG. 13 about the line B′-B′, and FIG. 14A is an enlarged view of a portion of a cam-lock used in conjunction with the discharge chute of FIG. 14.

The embodiment illustrated in FIGS. 11-14 and FIG. 14A has many features generally similar to those presented in earlier embodiments. For example, a housing 1120 is provided that may hold various components and may assist in protecting the components. A support beam 1124 may be provided that is secured to the housing 1120. A piston air control unit 1119 may be provided in the housing 1120 or at other locations to control the movement of pistons. A drip-pan control table 1126 may be provided, and this may control the movement of a drip-pan 1132. An enlarged portion 1136 of the discharge chute 1101 may have an enlarged external circumference or perimeter relative to other portions of the discharge chute 1101, and a chute mating flange 1134 may be provided proximate to the enlarged portion 1136. This chute mating flange 1134 may define a mating surface configured to engage with a container mating flange 1128 of a container 1102 to ensure a proper seal. An instrument plate 1138 is provided in the illustrated embodiment, and a proximity sensor 1142 and pressure relief tubing 1140 are provided on the instrument plate 1138. This pressure relief tubing 1140 may be proximate to the mating surface of the chute mating flange 1134 so that the pressure relief tubing 1140 may be in fluid communication with the interior of the container 1102.

In the embodiment illustrated in FIGS. 11-14 and 14A, the discharge chute 1101 includes a flexible coupling 1110 that interconnects a first (upper) rigid tubing 1165 and a second (lower) rigid tubing 1167 that are axially aligned with one another. In some embodiments, this coupling 1110 may be a bellows-type coupling. In particular, coupling 1110 is configured to expand and retract based on the movement of pistons 1113 (see FIG. 12). As the discharge chute extends and retracts, the mating surface at the chute mating flange 1134 may move along a path between an extended position and a retracted position. Additionally, a flow valve 1196 may also be provided to permit or inhibit the flow of material into the discharge chute 1101.

Referring specifically to FIG. 14, an inner lining 1176 may be placed in an interior passage of the discharge chute 1101 defined by first rigid tubing 1165, flexible coupling 1110, and second rigid tubing 1167. Inner lining 1176 may assist in maintaining a smooth interior surface for the material to flow even where a bellows-type coupling having an undulating inner surface is used. By providing a smooth inner surface, a relatively consistent boundary layer for the flow of materials may be provided. In some embodiments, the inner lining 1176 may be configured to be removable from the interior of the discharge chute 1101. The inner lining 1176 may include a flange 1176A that extends radially, and this flange 1176A may assist in securing the inner lining in place. This flange 1176A may be created by making two or more small cuts in the inner lining 1176 and folding the material proximate to these cuts so that that the material extends radially. While the flange 1176A is illustrated at an upper portion of the inner lining 1176, the flange 1176A may be provided at other positions on the inner lining 1176. The remainder of the inner lining 1176 may be a cylindrical portion that forms a flow path for material flowing in the discharge chute 1101. The inner lining 1176 may extend downwardly to a position proximate to the sealing interface between the discharge chute 1101 and the container 1102 when the discharge chute 1101 is in the extended position. In some embodiments, the inner lining 1176 may extend downwardly so that it is no longer than the length of the discharge chute 1101 in the retracted position. The inner lining 1176 may comprise a plastic material such as low density polyethylene material. The inner lining 1176 may have a thickness of approximately four mil in some embodiments, but other thicknesses may also be used.

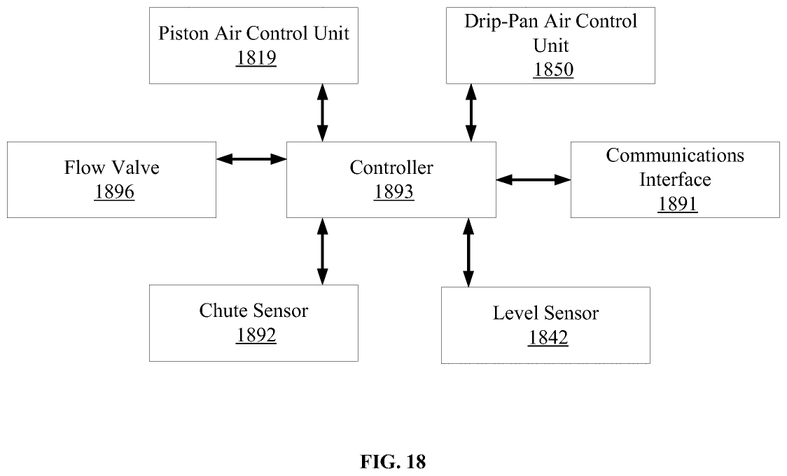

The embodiment illustrated in FIGS. 11-14 and 14A also include a plurality (e.g., three) sensors 1192 and corresponding plates 1194. However, a greater or lesser number of sensors 1192 and plates 1194 may be used. In this case, the plates 1194 are formed as finger-like members that extend radially under the sensors 1192 as shown. In some embodiments, the discharge chute 1101 may be oriented vertically so that the mating surface at the chute mating flange 1134 moves vertically as the mating surface moves between the extended position and the retracted position. As the discharge chute 1101 is extended, the sensors 1192 and corresponding plates 1194 may shift downwardly (or in other directions where the discharge chute is oriented differently). Once the discharge chute 1101 is extended a sufficient amount, mating flange 1134 makes initial contact with the mating flange of the container. As can be seen, enlarged portion 1136 carries its own expansion joint 1111 which compresses after the initial contact of mating flange 1134 as enlarged portion 1136 is moved downwardly by the pistons 1113. In this way, the sensors 1192 are moved physically closer to the plates 1194. The distance to the plates 1194 is determined, allowing the overall system to “know” when a good sealing engagement has been achieved. In this way, the sensors ensure that the chute mating flange 1134 is located in the correct position before any material is discharged through the discharge chute 1101. In particular, the sensors 1192 may ensure that the chute mating flange 1134 is oriented properly so that no gaps are provided along the perimeter of the chute mating flange 1134. A controller 1893 (see FIG. 18) may be configured to receive a signal from the plurality of sensors having an indication that the mating surface is sealed to a container, and the controller is configured to cause the flow valve to open, permitting flow of material into the discharge chute based on the indication that the mating surface is sealed to a container.

A lock 1190 is also provided in the embodiment illustrated in FIGS. 11-14 and 14A. This lock 1190 is a cam-lock in the illustrated embodiment, but other locking mechanisms may be utilized as well. Looking now at FIGS. 14 and 14A, the operation of lock 1190 may be more readily understood. A first member 1198 may be provided on the chute 1101, and this first member 1198 may include a recess 1199 where a portion of the lock 1190 may be received. In the illustrated embodiment, the cam-lock is in a locked state with the arm 1191 in a vertical position and with an associated cam at least partially positioned in the recess 1199. The arm 1191 of the cam-lock may be moved to place the cam-lock in an unlocked state with the associated cam located outside of the recess 1199.

The lock 1190 may be configured to secure a coupling that permits quick and efficient maintenance of the discharge chute 1101. For example, the lock 1190 may be used to open the coupling to access the inner lining 1176 for cleaning or replacement. Additionally, the lock 1190 may be used to open the discharge chute 1101 so that decontamination activities may be performed.

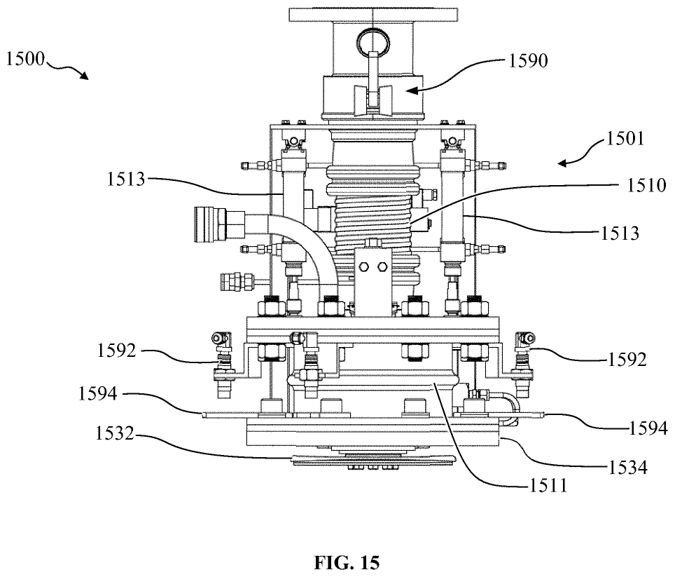

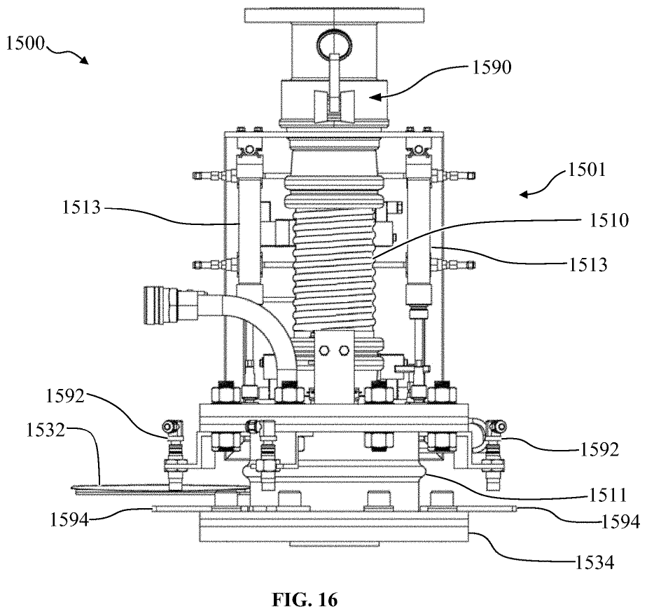

FIGS. 15 and 16 illustrate side views of an example disposal system 1500, showing the disposal system in an extended and retracted state. Similar to embodiments illustrated in earlier figures, one or more sensors 1592 and one or more plates 1594, and these may be used to ensure that the chute mating flange 1534 is located in the correct position before any material is discharged through the discharge chute 1501. Additionally, similar to the embodiments illustrated in earlier figures, a lock 1590 such as a cam-lock may be used.

FIG. 15 illustrates the disposal system 1500 in a retracted position. One or more pistons 1513 are used to move the disposal system 1500 between an extended position and a retracted position. These pistons 1513 may be attached to a ball linkage to provide flexibility for operations. In some embodiments, the pistons 1513 may be configured to operate using their full stroke lengths rather than completing only partial strokes, and this may eliminate the challenge of controlling a piston during its stroke and/or stopping the piston at a precise location mid-stroke. Where full stroke lengths are used, any extra stroke length may be absorbed by an expansion joint 1511.

In the embodiment illustrated in FIG. 15, a drip-pan 1532 is provided directly below the discharge chute 1501 to catch material that may fall from the discharge chute. The discharge chute 1501 also includes a fitting 1510, and this fitting 1510 may be a bellows type fitting that may be configured to expand and retract.

FIG. 16 illustrates the disposal system 1500 in an extended position. The drip-pan 1532 is also moved out from underneath the discharge chute 1501 in FIG. 16.

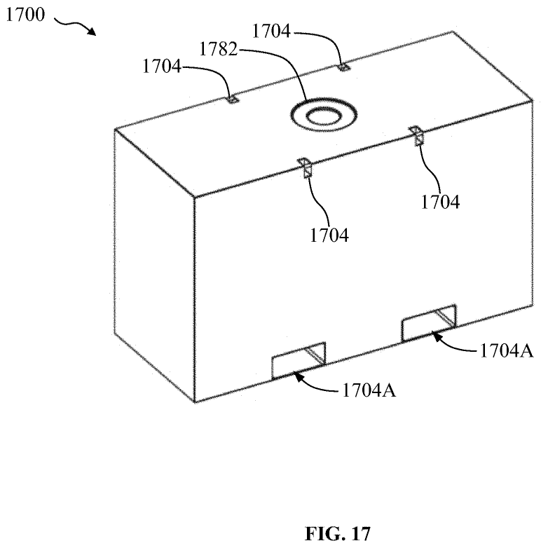

FIG. 17 is a perspective view of a container 1700. The container 1700 illustrated in FIG. 17 is similar to the container 700 illustrated in FIG. 7 in several respects. For example, the container 1700 comprises lifting pockets 1704. The container 1700 may also include additional lifting pockets 1704A proximate to a lower surface of the container 1700 so that the container 1700 may be easily lifted by a forklift. The container 1700 may also include a mating flange 1782 where a final sealing lid 802 (see FIG. 8A) may be provided.

FIG. 18 illustrates a block diagram of an example system with various electronic devices. A controller 1893 is provided. While a single controller is illustrated in FIG. 18, it should be understood that a plurality of controllers may also be used. Additionally, the term “controller” should be construed to include various computing devices, whether referred to as microcontrollers, processors, microprocessors, etc. In some cases, a controller may comprise multiple controllers with some of these controllers being dedicated to a specific sensor or component.

This controller 1893 may be configured to send and receive signals to the other components illustrated in FIG. 18. For example, the controller 1893 may send and receive signals with a flow valve 1896, a piston air control unit 1819, a drip-pan air control unit 1850, a chute sensor 1892, a level sensor 1842, and a communications interface 1891. The chute sensor 1892 may operate similar to the sensors 1592 of FIG. 15, and the level sensor 1842 may operate similar to the level sensor 242 of FIG. 2. The controller 1893 may be configured to cause the discharge chute 1101 (see FIG. 11) to extend and retract, and this may be done through communication with the piston air control unit 1819. However, where other systems or components are provided to actuate movement of components in the system (e.g., a pulley system), the controller 1893 may be configured to send and receive signals with these systems or components to cause the desired movement. The communications interface 1891 may be configured to send and receive signals with other computing devices. The communications interface 1891 may form connections with other computing devices in a variety of ways, including but not limited to a wired connection, a wireless connection, a WLAN, Wi-Fi, Bluetooth connection, etc. The controller 1893 may be configured to manage the operations of the disposal systems described herein. While this exemplary block diagram is provided, other components may also be connected to the controller 1893. Additionally, certain components may be omitted. Various connections between components may also be altered. For example, the controller 1893 may be configured to send and receive signals with one or more of the components shown in FIG. 18 via the communications interface 1891. The controller 1893 may also be configured to cause activation or deactivation of the drive conveyor associated with the track 108.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A disposal system for transferring material to a container comprising:
a discharge chute having a mating surface, wherein the mating surface is configured to mate with a container, wherein the discharge chute is configured to extend and retract so that the mating surface moves along a path between an extended position and a retracted position; and
at least one controller that is configured to cause the discharge chute to expand and retract.

2. The disposal system of claim 1, wherein the discharge chute includes an expandable fitting.

3. The disposal system of claim 2, wherein the expandable fitting is a bellows type fitting.

4. The disposal system of claim 1, further comprising an inner lining, wherein the discharge chute defines an interior passage, wherein the inner lining is configured to be secured within the discharge chute.

5. The disposal system of claim 4, wherein the inner lining is removable.

6. The disposal system of claim 1, wherein the discharge chute is oriented vertically so that the mating surface moves vertically as the mating surface moves between the extended position and the retracted position.

7. The disposal system of claim 1, further comprising a drip-pan, wherein the at least one controller is configured to move the drip-pan below the discharge chute, and wherein the at least one controller is configured to move the drip-pan out of the discharge chute path to avoid interference with the discharge chute when the mating surface is in the extended position.

8. The disposal system of claim 7, further comprising a drip-pan liner, wherein the drip-pan liner is configured be placed on the drip-pan, wherein the drip-pan liner is configured to be removable from the drip-pan.

9. The disposal system of claim 1, further comprising a plurality of sensors proximate to the mating surface to ensure that the mating surface is sealed to a container.

10. The disposal system of claim 9, further comprising a flow valve that is configured to permit and inhibit flow of material from a source into the discharge chute, wherein the at least one controller is configured to receive a signal from the plurality of sensors having an indication that the mating surface is sealed to a container, wherein the at least one controller is configured to cause the flow valve to permit flow of material into the discharge chute based on the indication that the mating surface is sealed to a container.

11. The disposal system of claim 1, further comprising coupling having a lock, wherein the coupling is configured to allow access to an interior of the discharge chute.

12. The disposal system of claim 11, wherein the lock is a cam-lock.

13. The disposal system of claim 1, wherein the disposal system is configured to transfer hazardous material.

14. The disposal system of claim 13, further comprising a pressure relief vent proximate to the mating surface.

15. The disposal system of claim 1, further comprising a track, wherein the track is configured to receive one or more containers.

16. The disposal system of claim 15, further comprising a drive conveyor, wherein the drive conveyor is configured to move one or more containers along the track.

17. The disposal system of claim 1, wherein the at least one controller is configured to cause activation or deactivation of the drive conveyor.

18. A containment assembly for use with radioactive materials, the containment assembly comprising:
a sealing lid comprising a locking pin; and
a top face having a cylindrical chamber opening where the sealing lid may be received, the cylindrical chamber opening having a pocket,
wherein the pocket is configured to receive the locking pin.

19. The containment assembly of claim 18, wherein the cylindrical chamber opening has a guide track defining a downward slope and wherein the pocket is provided in the guide track.

20. A method for operating a disposal system comprising:
providing a discharge chute,
providing a drip-pan below the discharge chute;
providing a container below the discharge chute and the drip-pan, wherein the discharge chute is in a retracted position;
moving the drip-pan so that it is not directly below the discharge chute; and
extending the discharge chute downwardly to an extended position to form a seal with the container, wherein the drip-pan does not interfere with the extension of the discharge chute.

21. The method of claim 20, further comprising:
providing a flow valve that is configured to permit or inhibit flow of material into the discharge chute;
detecting a seal between the discharge chute and the container; and
causing the flow valve to be opened to permit flow of a material into the discharge chute.

22. A method for operating a disposal system comprising:
providing a discharge chute and a container, wherein a seal exists between the discharge chute and the container;
providing a drip-pan;
retracting the discharge chute upwardly to a retracted position; and
moving the drip-pan below the discharge chute and above the container so that the drip-pan catches material falling from the discharge chute.
